(19) United States
(12) Patent Application Publication
(10) Pub. No.: US 2025/0271834 A1
(43) Pub. Date: Aug. 28, 2025

(54) PRODUCTION MANAGEMENT DEVICE, PRODUCTION MANAGEMENT METHOD, AND PROGRAM

(71) Applicant: Hitachi, Ltd., Tokyo (JP)

(72) Inventors: Takahiro NAKANO, Tokyo (JP); Youichi NONAKA, Tokyo (JP)

(21) Appl. No.: 18/857,968

(22) PCT Filed: Feb. 15, 2023
(86) PCT No.: PCT/JP2023/005133

§ 371 Date: Oct. 18, 2024

(30) Foreign Application Priority Data
Apr. 22, 2022 (JP) 2022-070825

(51) Int. Cl. G05B 19/4099

(52) U.S. Cl. CPC G05B 19/4099; G05B 2219/31372

(57) ABSTRACT

If a deviation occurs between a production plan and actual production results, a change proposal is generated for a more appropriate production plan, process plan, and resource control information by a production management device. Product production management is performed using product production plan information, process plan information pertaining to the product production processes, and resource control information defining the operation of production resources, which are manufacturing equipment. If a deviation occurs between the product production plan and actual production results that indicate the progress of production, in the course of the production management carried out using the first production plan information, the first process plan information, and the first resource control information, a determination is made to use a second process plan information and second resource control information, which are different from the first process plan information and the first resource control information.

### TECHNICAL FIELD

The present invention relates to a production management device, production management method and program. The present invention claims priority of Japanese Patent Application No. 2022-070825, filed on Apr. 22, 2022. For designated states in which any incorporation by reference of literature is approved, the contents disclosed in the application is incorporated herein by reference in its entirety.

### BACKGROUND ART

In conventional production management, if a deviation occurs between a production plan and actual production results, the way of reducing the range of deviation is taken by changing the production plan to follow the actual production results.

On the other hand, because of recent developments of mass customization and personalized production, accepting orders in high-mix low-volume production is on an upward trend. To deal with the problem of the deviation between a production plan and actual production results with consideration given to such trend, there is need to review the assignment of production resources (production equipment) to varieties.

Also, the diversification of workers and/or the introduction of general-purpose robots causes an increase in work delay and/or equipment failure. To deal with the problem of the deviation between a production plan and actual production results with consideration given to such trend, there is need to review the information about operation control on the production resource.

In this manner, a target production efficiency is not easily achieved only by taking a measure to change only the production plan against the problem of the deviation between the production plan and actual production results.

It is noted that Patent Literature 1 discloses technology relating to a method for providing support for editing a work plan in order to obtain an appropriate process plan. Specifically, this literature describes that, where work assigned to persons is changed to be performed by a robot arm, if the working time of the robot after change is longer than the working time of the person, an alarm is output.

### CITATION LIST

### Patent Literature

Patent Literature 1: Japanese Unexamined Patent Application Publication No. 2019-148958

### SUMMARY OF INVENTION

### Technical Problem

As described above, in the technology of Patent Literature 1, the work plan is reviewed by changing a destination to which the work is assigned, in order to obtain an appropriate process plan. However, in the technology, no consideration is given to the impact on the overall product manufacture, such as how the amount of product production is changed by changing the work plan.

Typically, for products, the overall amount of production (or production efficiency) is determined by mutual involvement, and simultaneously, cooperation (coordination) of: a production plan about production time of year and/or the amount of production; a process plan about the equipment configuration represented by equipment types and the number of pieces of the equipment used in a production line, and/or about assignment and work details of production resources on the production line; and resource control information about operation control for each production resource. That is, an appropriate judgment cannot be made on the impact on the overall amount of production only by reviewing the work plan. Therefore, there is a problem of a difficult achievement of a target production efficiency even if the technology of Patent

Literature 1 is applied when a deviation occurs between the production plan and actual production results.

Further, as described above, the conventional production management with a measure taken to change only the production plan has a problem of being unable to achieve a target production efficiency if a deviation occurs between the production plan and actual production results.

The present invention has been made in view of the above problems and it is an object thereof to generate a change proposal for more appropriate production plan, process plan and resource control information if a deviation occurs between a production plan and actual production results.

### Solution to Problem

The present application includes a plurality of means for solving at least some of the above problems, and the following are some examples. A production management device according to an aspect of the present invention to solve the above problems is a production management device that performs product production management using product production plan information, process plan information pertaining to the product production process, and resource control information defining the operation of production resources, which are manufacturing equipment. If a deviation occurs between the product production plan and actual production results that indicate the progress of production, in the course of the production management carried out using the first production plan information, the first process plan information and the first resource control information, a determination is made to use the second process plan information and the second resource control information, which are different from the first process plan information and the first resource control information, instead of the first process plan information and the first resource control information.

### Advantageous Effects of Invention

According to the present invention, it is possible to generate a change proposal for more appropriate production plan, process plan and resource control information if a deviation occurs between a production plan and actual production results.

### BRIEF DESCRIPTION OF DRAWINGS

FIG. 1 is a diagram illustrating an example of schematic configuration of a production management device according to the embodiment.

FIG. 2 is a diagram illustrating an example of actual production result information.

FIG. 3 is a diagram illustrating an example of production plan information.

FIG. 4 is a diagram illustrating an example of process plan information.

FIG. 5 is a diagram illustrating an example of resource control information.

FIG. 6 is a diagram illustrating an example of product quantity information.

FIG. 7 is a diagram illustrating an example of component shape information.

FIG. 8 is a flowchart illustrating an example of production management processing.

FIG. 9 is a diagram illustrating an example of hardware configuration of the production management device.

### DESCRIPTION OF EMBODIMENTS

Embodiments of the present invention will be described below with reference to the accompanying diagrams.

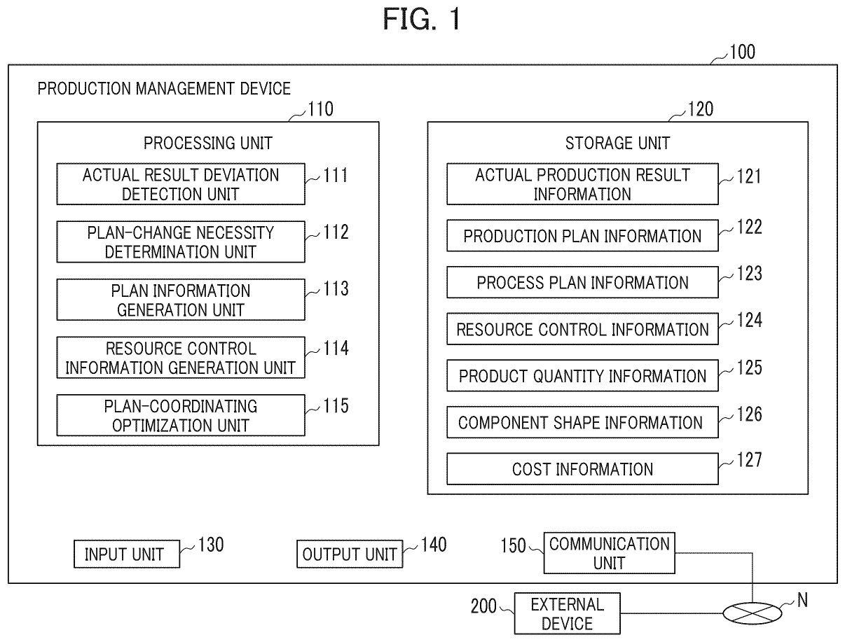

FIG. 1 is a diagram illustrating an example of schematic configuration of a production management device 100 according to the embodiment. The production management device 100 is a device for generating change proposals of process plan information and resource control information corresponding thereto if a deviation occurs between a production plan and actual production results indicating the progress with respect to the production plan, and the device for creating a change proposal of the production plan in coordination with the change proposals of the process plane and/or the like such that predetermined production KPIs (Key Performance Indicator) such as manufacturing cost, production throughput and/or the like are optimized.

As illustrated in FIG. 1, such production management device 100 has a processing unit 110, a storage unit 120, an input unit 130, an output unit 140 and a communication unit 150.

The processing unit 110 is a function unit for performing various kinds of processing to be executed by the production management device 100. Specifically, the processing unit 110 has an actual result deviation detection unit 111, a plan-change necessity determination unit 112, a plan information generation unit 113, a resource control information generation unit 114 and a plan-coordinating optimization unit 115.

The actual result deviation detection unit 111 is a function unit for detecting a deviation between a production plan and actual production results. Specifically, the actual result deviation detection unit 111 detects a deviation of a delay of days or a deviation of the amount of production.

More specifically, the actual result deviation detection unit 111 uses production plan information 122 and actual production result information 121 to identify a difference between a planned value for the same objective products (e.g., an end time of a process identified from the production plan information 122) and an actual value (an end time of a process identified from the actual production result information 121). Also, if the identified difference is at or above a predetermined threshold value (e.g., one day or longer), the actual result deviation detection unit 111 determines that a deviation is detected between a production plan and actual production results (a deviation of a delay of days).

The actual result deviation detection unit 111 also uses the production plan information 122, the actual production result information 121 and a product quantity information 125 to identify a ratio of a difference between a planned value for the same objective products (e.g., a scheduled production volume identified from the production plan information 122 and the product quantity information 125) and an actual value (an actual predicted production volume identified from the actual production result information 121). Also, if the identified ratio of the difference is less than a predetermined threshold value, the actual result deviation detection unit 111 determines that a deviation is detected between a production plan and actual production results (a deviation of the amount of production).

The plan-change necessity determination unit 112 is a function unit for determining, based on a magnitude of a deviation between a production plan and actual production results, whether or not a change of a process plan and a production plan in coordination with each other is required. Specifically, if the magnitude of the deviation is at or above the predetermined threshold value, the plan-change necessity determination unit 112 determines that a change of a process plan and a production plan in coordination with each other is required.

The plan information generation unit 113 is a function unit for generating various items of plan information. Specifically, the plan information generation unit 113 generates the production plan information 122, the process plan information 123 and the change proposals of them.

The resource control information generation unit 114 is a function unit for generating resource control information 124. Specifically, the resource control information generation unit 114 generates the resource control information 124 for defining the operation of a production resource, and the change proposal of it.

The plan-coordinating optimization unit 115 is a function unit for coordinating and optimizing a plurality of plans with each other. Specifically, the plan-coordinating optimization unit 115 uses the change proposal of the process plan information 123 and the resource control information 124 to create a change proposal of the production plan in coordinative manner.

Next, the storage unit 120 is described. The storage unit 120 is a function unit for storing various items of information used in various procedures of the processing to be executed by the processing unit 110. Specifically, the storage unit 120 has the actual production result information 121, the production plan information 122, the process plan information 123, the resource control information 124, the product quantity information 125, component shape information 126, and cost information 127.

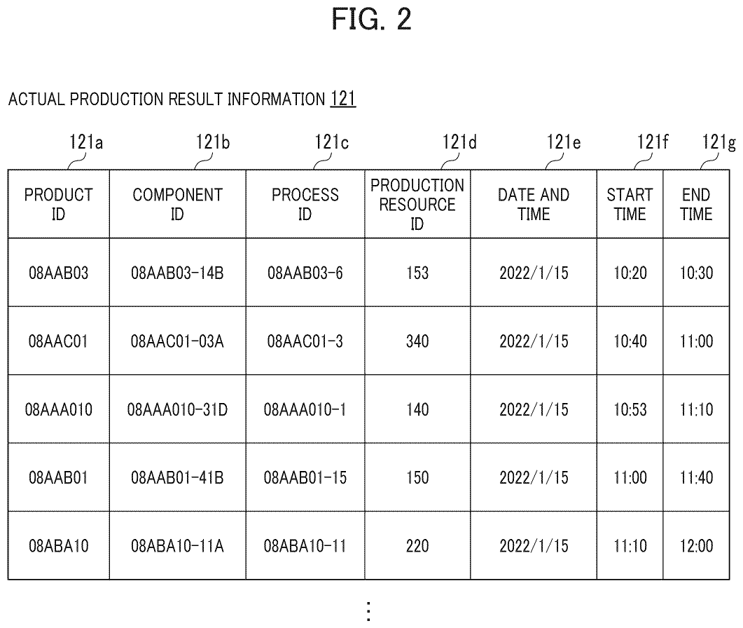

FIG. 2 is a diagram illustrating an example of the actual production result information 121. The actual production result information 121 is registered with information representing actual results (progress results) of the production plan. Specifically, a product ID 121a in the actual production result information 121 is information for identifying a product. A component ID 121b is information for identifying a component. A process ID 121c is information for identifying a process. A production resource ID 121d is information for identifying a production resource. A date and time 121e is information representing a date and time at which a predetermined process of, e.g., mounting a component of the corresponding component ID 121b, and/or the like, is performed in the production of a product identified by the associated product ID 121a. A start time 121f is information representing a time at which a process identified by the associated process ID 121c is started. An end time 121g is information representing a time at which the process in question is ended.

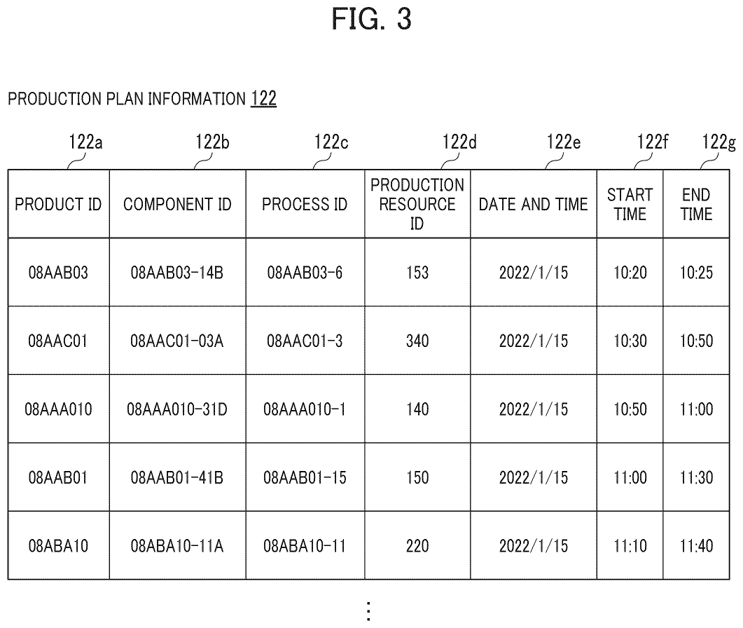

FIG. 3 is a diagram illustrating an example of the production plan information 122. The production plan information 122 is registered with information representing production timing such as, e.g., a date and time at which each process in the product manufacture is performed, a start time and an end time. Specifically, a product ID 122a in the production plan information 122 is information for identifying a product to be manufactured. A component ID 122b is information for identifying a component partially making up a product. A process ID 122c is information for identifying a process. A production resource ID 122d is information for identifying a production resource. A date and time 122e is information representing a date and time at which a predetermined process of, e.g., mounting a component of the corresponding component ID 122b, and/or the like, is performed in the production of a product identified by the associated product ID 122a. A start time 122f is information representing a scheduled start time of a process identified by the associated process ID 122c. An end time 122g is information representing a scheduled end time of the process.

It is noted that each item of the production plan information 122 corresponds to each item of the actual production result information 121, and upon completion of a process identified by the process ID 122c for objects identified by the product ID 122a and the component ID 122b in the production plan information 122, information about the objects in question is registered as actual production results in the actual production result information 121.

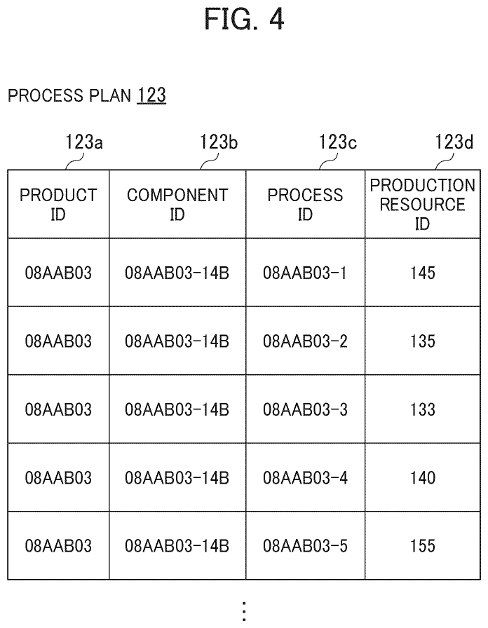

FIG. 4 is a diagram illustrating an example of the process plan information 123. The process plan information 123 is registered with information about process of manufacturing a product. Specifically, a product ID 123a in the process plan information 123 is information for identifying a product to be manufactured. A component ID 123b is information for identifying a component partially making up a product. A process ID 123c is information for identifying each process. A production resource ID 123d is information for identifying a production resource used in each process.

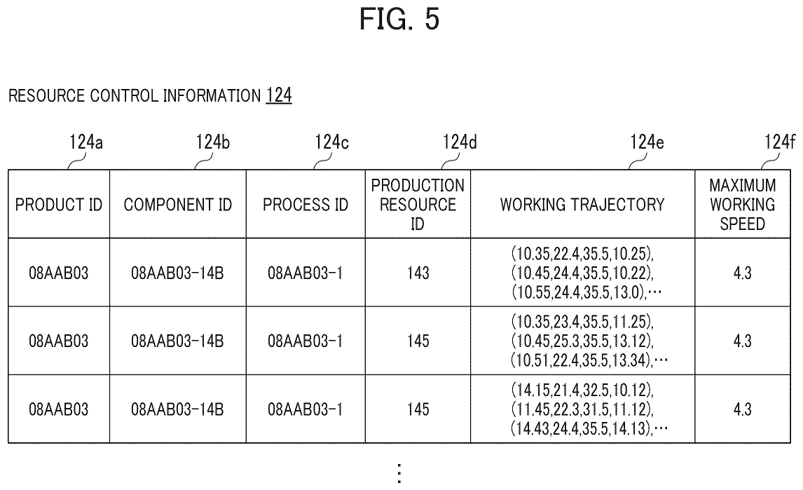

FIG. 5 is a diagram illustrating an example of the resource control information 124. The resource control information 124 is registered with control information for defining the operation of a production resource. Specifically, each record of the resource control information 124 is registered with information such as on a working trajectory (e.g., a movable trajectory of an arm) and/or a maximum working speed thereof when a process work identified by the process ID 124c is performed by a production resource (e.g., equipment such as a manufacturing robot and/or the like) identified by the production resource ID 124d. More specifically, the product ID 124a and the component ID 124b are information for identifying a product and a component which are under a process work identified by the process ID 124c. A process ID 124c is information for identifying work in a process. A production resource ID 124d is information for identifying a production resource that performs process work. A working trajectory 124e is information representing an operation trajectory of a production resource, which is registered with information representing coordinate values in a predetermined coordinate system. A maximum working speed 124f is information representing a maximum working speed of a production resource.

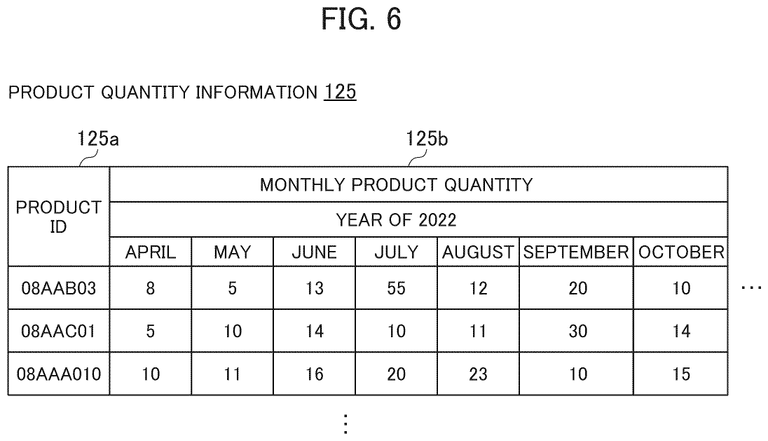

FIG. 6 is a diagram illustrating an example of the product quantity information 125. The product quantity information 125 is information representing a scheduled production volume in each session for products manufactured according to a production plan. Specifically, a product ID 125a in the product quantity information 125 is information for identifying a product. Also, a monthly product quantity 125b is information representing a scheduled production volume of objective products in a predetermined objective session.

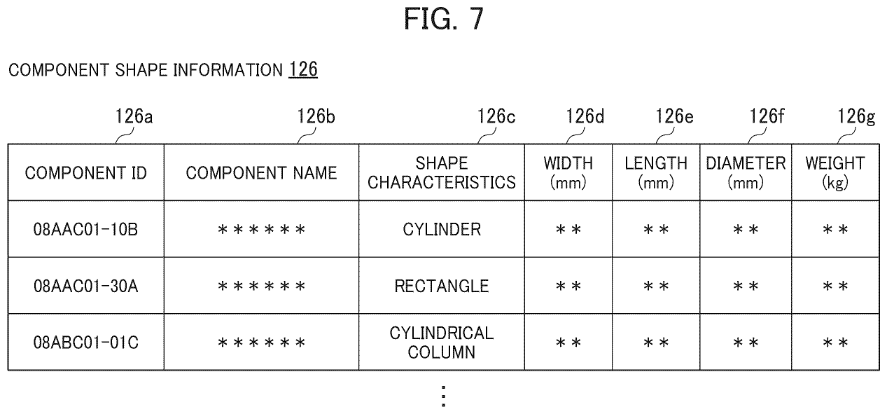

FIG. 7 is a diagram illustrating an example of the component shape information 126. The component shape information 126 is information about a shape of a constituent component partially making up a product. Specifically, a component ID 126a in the component shape information 126 is information for identifying a component. A component name 126b is information representing a name of a component. Shape characteristics 126c are information representing geometric features of a component, such as, e.g., a cylinder, a rectangle, a cylindrical column or the like. Each of a width 126d, a length 126e, a diameter 126f and a weight 126g is information representing a width, a length, a diameter or a weight of a component.

The cost information 127 is information registered with various costs. The cost information 127 is also registered with costs incurred in connection with, for example, a change of a production plan and/or a process plan. Specifically, the cost information 127 includes, for example: equipment costs required for an arrangement change of equipment such as production resources and/or the like in a factory layout; costs to operate a production resource; a ratio of profit to production yield; outsourcing costs including cost per unit time of a worker and cost of overtime work of a worker; penalty costs for delayed deliveries of products; penalty costs for delayed work; and/or the like.

Referring back to FIG. 1, a description is provided. The input unit 130 is a function unit for receiving input of instructions and/or information from a user (operator) of the production management device 100 through an input device mounted in the production management device 100. The input unit 130 also receives input of instructions and/or information from the external device 200 through the communication unit 150.

The output unit 140 is a function unit for generating output information (including display information) and displaying the display information on an output device 320 (including a display) mounted in the production management device 100 or the external device 200. The output unit 140 also generates control instruction information for performing operation control on the production resource, and outputs (transmits) the control instruction information to each production resource on a production line through the communication unit 150.

The communication unit 150 is a function unit for establishing information communication with the external device 200. Specifically, the communication unit 150 transmits/receives various items of information to/from the external device 200 through a network (communication network) N such as the Internet, LAN (Local Area Network), and/or the like.

One example of schematic configuration (function blocks) of the production management device 100 has been described above.

### Description of Operation

The following is a description of production management processing executed by the production management device 100.

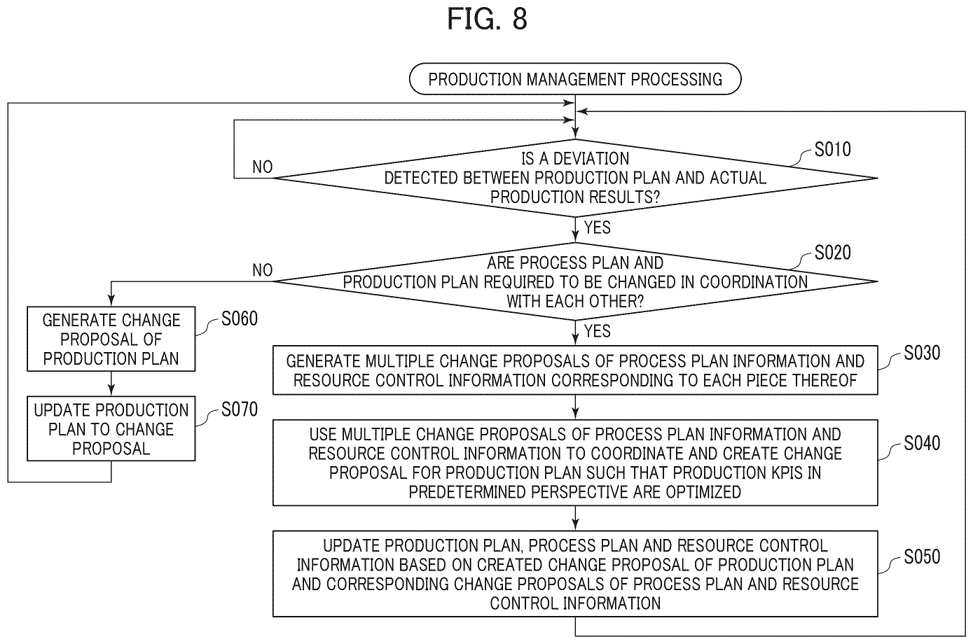

FIG. 8 is a flowchart illustrating an example of the production management processing. The production management processing is processing for generating a change proposal of each of the process plan information 123 and the resource control information 124 corresponding to the process plan information 123 if a deviation occurs between a production plan and actual production results that indicate the progress with respect to the production plan, and then the processing is performed for creating a change proposal of the production plan in coordination with the change proposals of the process plane and/or the like such that predetermined KPIs such as manufacturing cost, production throughput and/or the like are optimized.

It is noted that the production management processing is executed in a constant cycle (e.g., once a day, once a week or the like) when, for example, an execution instruction is received from a user (operator) of the production management device 100.

Upon beginning of the processing, the actual result deviation detection unit 111 determines whether or not a deviation between a production plan and actual production results is detected (step S010). Specifically, the actual result deviation detection unit 111 acquires the production plan information 122 and the actual production result information 121 from the storage unit 120. The actual result deviation detection unit 111 then makes a comparison between an actual value of the actual production result information 121 and a planned value of the production plan information 122 for the same object.

More specifically, the actual result deviation detection unit 111 identifies a record of the actual production result information 121 on which processing in the step is not yet performed. The actual result deviation detection unit 111 also identifies a product ID 121a, a component ID 121b, a process ID 121c and a production resource ID 121d in each of the identified records. The actual result deviation detection unit 111 also identifies a record of the production plan information 122 in which the same IDs as the identified IDs are registered.

The actual result deviation detection unit 111 also makes a comparison between end times in the identified records of the actual production result information 121 and the production plan information 122. Then, if there exists a record in which the end time of the actual production result information 121 is a predetermined threshold value or greater (e.g., one day or longer) behind the end time of the production plan, the actual result deviation detection unit 111 determines that a deviation is detected between the production plan and the actual production results (a deviation of a delay of days).

Alternatively, the actual result deviation detection unit 111 may use the actual production result information 121, the production plan information 122 and the product quantity information 125 to detect a deviation (deviation of the amount of production) between a scheduled production volume based on the production plan and an actual predicted production volume based on the actual production results.

Specifically, the actual result deviation detection unit 111 acquires the actual production result information 121, the production plan information 122 and the product quantity information 125 from the storage unit 120. The actual result deviation detection unit 111 also identifies a record of the actual production result information 121 on which the processing of the step is not yet performed. The actual result deviation detection unit 111 also identifies, as a scheduled production volume based on the production plan, a product quantity of a relevant month in the product quantity information 125 in which a product ID 121a of each of the identified records is registered.

The actual result deviation detection unit 111 also calculates a degree of delay from the production plan based on the end time 121g in each of the identified records in the actual production result information 121. The actual result deviation detection unit 111 also calculates, based on the degree of delay in question, an actual predicted production volume based on the actual production results for products of the corresponding production ID 121a, as a predicted value of the product quantity in a relevant month. Then, if a ratio of the actual predicted production volume to the scheduled production volume is less than a predetermined threshold value (e.g., less than 90%), the actual result deviation detection unit 111 determines that a deviation is detected between a production plan and actual production results for the products of the product ID 121a in question (a deviation of the amount of production).

The actual result deviation detection unit 111 makes a determination by any method, and performs the processing in step S010 again if it is determined to detect no deviation between a production plan and actual production results (NO at step S010). On the other hand, if it is determined to detect the deviation in question (YES at step S010), the actual result deviation detection unit 111 causes the processing to move to step S020.

In step S020, the plan-change necessity determination unit 112 determines, based on the magnitude of the deviation, whether or not a process plan and a production plan are required to be changed in coordination with each other. Specifically, if the magnitude of the deviation is at or above the predetermined threshold value, the plan-change necessity determination unit 112 determines that a change of a process plan and a production plan in coordination with each other is required. It is noted that, as an example of threshold values, in the case of a deviation of a delay of days, a delay is three days or longer, and in the case of a deviation of the amount of production, a ratio of an actual predicted production volume to a scheduled production volume is less than 70%, and the like.

If it is determined that a change of a process plan and a production plan in coordination with each other is not required (NO in step S020), the plan-change necessity determination unit 112 causes the processing to move to step S060. It is noted that, in step S060, the plan information generation unit 113 generates a change proposal of the production plan information 122. This is because measures can be taken only by changing the production plan information 122 because of a small deviation between the production plan and the actual production results. It is noted that the plan information generation unit 113 uses the production plan information 122, the actual production result information 121 and other various items of information within the storage unit 120 to generate a change proposal of the production plan information 122 by well-known techniques.

The plan information generation unit 113 also changes the production plan information 122 to the change proposal (step S070), and the processing moves back to step S010.

On the other hand, if it is determined that a change of a process plan and a production plan in coordination with each other is required (YES in step S020), the plan-change necessity determination unit 112 causes the processing to move to step S030.

In step S030, the plan information generation unit 113 and the resource control information generation unit 114 generate a plurality of change proposals of the process plan information 123 and the resource control information 124 corresponding to respective pieces thereof. Specifically, the plan information generation unit 113 generates a change proposal of the process plan information 123 about the equipment configuration represented by equipment types and the number of pieces of the equipment used on a production line, and/or about assignment and work details of production resources on the production line. The plan information generation unit 113 also generates a change proposal of the resource control information 124 corresponding to the change proposal of each piece of the process plan information 123 to define the operation of each production resource. It is noted that the methods of generating the process plan information 123 (including the change proposal) and the resource control information 124 (including the change proposal) are not particularly limited, and one such example is described below.

Initially, the plan information generation unit 113 identifies, from the component shape information 126, a constituent component corresponding to the process and a component ID 126a of a component resembling the constituent component. The plan information generation unit 113 identifies, from the actual production result information 121, a production resource associated with the component IDs 126a.

The plan information generation unit 113 also uses a plurality of identified production resources as candidates for production resources in the process in question, and assigns, to each process, a predetermined number (e.g., 10) of production resource candidates and the production resource candidates providing a shorter period of working time for the process.

The plan information generation unit 113 also performs the same processing on all the constituent components of all the objective products in order to generate a plurality of different pieces of process plan information 123 for assigning, for each product, a predetermined number of production resource candidates to each process corresponding to each constituent component. It is noted that a technology described in, for example, Japanese Patent Application No. 2020-144537 may be used for the method of generating such process plan information 123.

Also, as another example of the method of generating a process plan, a technology described in, for example, Japanese Patent Application No. 2020-030479 may be used. Specifically, a plan information generation unit 113 generates a plurality of different sets of process and equipment in which the calculated predetermined number of pieces of equipment (module group) is assigned to a corresponding process. The plan information generation unit 113 also estimates a period of working time based on the arrangement, operational rules and/or the like within a cell in a factory layout of the equipment in question (module group). The plan information generation unit 113 also identifies a set of a predetermined number of processes and equipment which provides a shorter period of working time within a cell. Then the plan information generation unit 113 generates a plurality of pieces of process plan information 123 with consideration given to the order of works for all the constituent components in all the objective products. It is noted that the equipment is assigned to processes; accordingly, the number of pieces of the equipment required in each process is determined. Therefore, the process plan information 123 thus generated includes the equipment configuration in a production line represented by the equipment types and the number of pieces of the equipment used in the production line.

Where the process plan information 123 is generated by such a method, necessary information (e.g., component attribute information, module group specification information, module specification information, module operational pattern information, layout information and the like) may be previously stored in the storage unit 120 or may be acquired from the external device 200 through the communication unit 150.

The resource control information generation unit 114 also generates a change proposal of the resource control information 124 which corresponds to each change proposal of the generated process plan information 123 to cause the production resource to execute the process plan relating to the change proposal in question. It is noted that the method of generating the resource control information 124 is not particularly limited, and a well-known technique of generating a robot trajectory may be used such as, e.g., RRT (Rapidly-exploring Random Tree) algorism and/or the like.

A plurality of change proposals of the process plan information 123 and the resource control information 124 corresponding thereto may be previously stored in the storage unit 120.

Subsequently, the plan-coordinating optimization unit 115 uses a predetermined production KPI as a target function to coordinate and concurrently optimize a plurality of change proposals of the process plan information 123 and the resource control information 124 and the production plan information 122 with each other in order to create a change proposal of the production plan (step S040).

Specifically, the plan-coordinating optimization unit 115 coordinates the change proposals of the process plan information 123 and the resource control information 124 with each other to create a change proposal of the production plan information 122 by solving the optimization problem on combination of the plurality of change proposals of the process plan information 123 and the resource control information 124 with the production plan information 122 such that predetermined production KPIs such as manufacturing cost and production throughput are maximized (optimized).

As a technique for optimization, for example, a well-known technology may be used such as a metaheuristic method such as MIP (Mixed Integer Programming), Solver, GA (Genetic Algorithm) or the like.

Specifically, the plan-coordinating optimization unit 115 uses one of the change proposals of the process plan information 123 and the resource control information 124 corresponding thereto, and various items of information within the storage unit 120 to perform a production simulation while changing production timing (e.g., a date and time, a start time and an end time) in the production plan information 122, in order to calculate a predetermined production KPI at each timing. The plan-coordinating optimization unit 115 also acquires other change disposals of the process plan information 123 and the resource control information 124 from the storage unit 120, and then the plan-coordinating optimization unit 115 uses the change proposals in question and the production plan information 122 to perform a similar production simulation in order to calculate a predetermined production KPI. The plan-coordinating optimization unit 115 repeatedly performs the production simulation using the production plan information 122, for all the change proposals of the process plan information 123 and the resource control information 124 in this manner. Thereby, the plan-coordinating optimization unit 115 is able to create a change proposal of the production plan information 122 to maximize the predetermined production KPI. Through such processing, a set of change proposals of the process plan information 123 and the resource control information 124 is determined to correspond to the created a change proposal of the production plan information 122.

It is noted that the production KPI is not limited to the manufacturing cost and the production throughput, and may be set based on a user's important perspective as appropriate. Therefore, other than the production KPI such as the manufacturing cost and the production throughput, for example, a product yield rate and/or another production KPI may be to be maximized.

Here, a description is given of each production KPI and kinds of information used in the calculation thereof. The manufacturing cost is cost attendant on the changes of the production plan and the process plan. Specifically, the manufacturing cost includes at least one of the following: equipment costs required for an arrangement change of equipment such as production resources and/or the like in a factory layout; costs to operate a production resource; a ratio of profit to production yield; outsourcing costs including cost per unit time of a worker and cost of overtime work of a worker; penalty costs for delayed deliveries of products; and penalty costs for delayed work. It is noted that a concrete value of such manufacturing cost may be calculated by performing a production simulation using the change proposals of the production plan information 122, the process plan information 123 and the resource control information 124, and the cost information 127.

Also, the production throughput is an average production volume of products at a predetermined time (e.g., per minute) in a predetermined period of time (e.g., one month). Such a production throughput may be determined based on a predicted value which is calculated by performing a production simulation using the production plan information 122, the change proposals of the process plan information 123 and the resource control information 124, and the product quantity information 125.

The plan-coordinating optimization unit 115 may use the process plan information 123 and the corresponding resource control information 124 to determine net working time of a production resource and setup time for the production resource to work. Then, a production throughput may be calculated in consideration of the net working time and the setup time. For example, where net working time associated with each of the process IDs of the production resources is registered in the process plan information 123 (including the change proposal of the process plan information 123) or the resource control information 124 (including the change proposal of the resource control information 124), the plan-coordinating optimization unit 115 determines net working time of the production resource from this information. The plan-coordinating optimization unit 115 calculates, for example, a time interval between processes as the setup time, and then uses the determined net working time and the setup time to execute a production simulation, thereby calculating a production throughput. By performing production simulation in consideration of the net working time and the setup time in this manner, a predicted value of the production throughput will be calculated with greater precision.

A product yield rate is a ratio of a production volume resulting from actual production to a target production volume in a predetermined period of time (e.g., one month). Such a product yield rate may be calculated by performing a production simulation using, for example, the production plan information 122, the change proposals of the process plan information 123 and the resource control information 124, and the product quantity information 125.

The maximization (optimization) of manufacturing cost is the case where the manufacturing cost takes a lower value. The maximization (optimization) of production throughput is the case where the production throughput takes a higher value. The maximization (optimization) of product yield rate is the case where the yield rate takes a higher value.

In the processing in step S040, a change proposal of the production plan information 122 may be created in coordination with the change proposals of the process plan information 123 and the resource control information 124 such that at least one of production KPIs is maximized. Alternatively, the processing in question may be performed such that an arbitrary number of production KPIs is maximized.

As described above, the change proposals of the production plan information 122, the process plan information 123 and the resource control information 124 for maximization of production KPI(s) are employed to perform the production management based on these change proposals. This results in the maximization of production throughput and manufacturing cost and also a reduction in deviation between a production plan and actual production results. For example, the change proposals resulting in the maximization of production throughput correspond to the production plan and/or the process plan which cause the improvement in production efficiency. Therefore, performing the production management based on such change proposals will reduce the range of deviation of a delay of days and/or of the amount of production to achieve a target production efficiency.

For example, the manufacturing cost includes a ratio of profit to production yield, outsourcing cost including cost per unit time of a worker and cost of overtime work of a worker, penalty costs for delayed deliveries of products and penalty costs for delayed work. Because the costs are increased by a delay of the production plan, a change proposal to maximize the manufacturing cost (a lower value of the manufacturing cost) corresponds to a production plan and a process plan with a shorter delay with reference to the original production plan. Therefore, performing the production management based on such change proposals will reduce the range of deviation of a delay of days and/or of the amount of production to achieve a target production efficiency.

Subsequently, the plan-coordinating optimization unit 115 updates the production plan information 122, the process plan information 123 and the resource control information 124 based on the created change proposal of the production plan information 122 and the corresponding change proposals of the process plan information 123 and the resource control information 124 (step S050). As a result of this, the production management is performed in accordance with the production plan information 122, the process plan information 123 and the resource control information 124 in conditions in which the production KPIs are optimized for the deviation between the production plan and the actual production results.

Specifically, a predetermined function unit (e.g., the output unit 140) of the production management device 100 generates control instruction information for performing control on the production resource, based on the updated process plan information 123 and the updated resource control information 124 in accordance with the updated production plan information 122. Then, the predetermined function unit outputs (transmits) the control instruction information in question toward each production resource in a production line through the communication unit 150. In this manner, the production management device 100 performs operational control in each process by the production resource based on the changed production plan information 122, the changed process plan information 123 and the changed resource control information 124.

The plan-coordinating optimization unit 115 performs the processing in step S050, and then returns the processing to step S010.

One example of the production management processing has been described.

With such a production management device, if a deviation occurs between a production plan and actual production results, change proposals are able to be generated for more appropriate production plan, process plan information and resource control information.

In particular, the production management device creates, in coordination with the change proposals of the process plan information and the resource control information, a change proposal of the production plan information such that the production KPIs in predetermined perspectives are maximized. Therefore, it is possible to generate the production plan information, the process plan information and the resource control information which are appropriate to optimize the production KPIs, such as e.g., manufacturing cost and the production throughput while accordingly reducing the range of deviation between the production plan and the actual production results. As a result, with the production management device, it is possible to reduce the deviation between the production plan and the actual production results to achieve a target production efficiency.

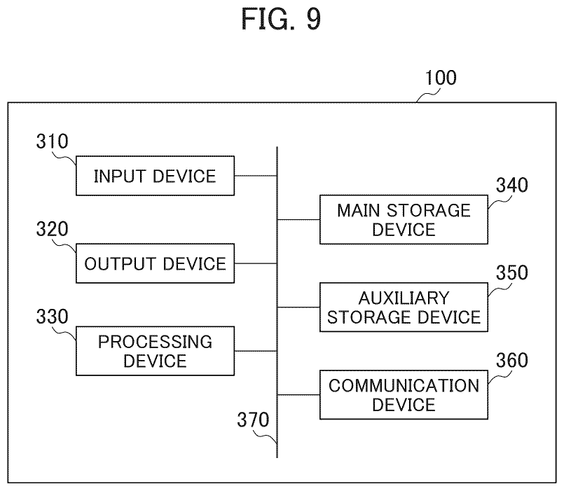

FIG. 9 is a diagram illustrating an example of hardware configuration of the production management device 100. As illustrated in the figure, the production management device 100 has an input device 310, an output device 320, a processing device 330, a main storage device 340, an auxiliary storage device 350, a communication device 360 and a bus 370 electrically interconnecting them.

The input device 310 is an input device such as e.g., a touch panel, a keyboard, a mouse and/or the like. The output device 320 is a display device such as a liquid crystal display, an organic display and/or the like.

The processing device 330 is, for example, a CPU (Central Processing Unit). The main storage device 340 is a memory device such as RAM (Random Access Memory), ROM (Read Only Memory) and/or the like.

The auxiliary storage device 350 is a nonvolatile storage device such as a so-called hard disk (Hard Disk Drive), SSD (Solid State Drive), flash memory or the like which is capable of storing digital information.

The communication device 360 is a wired communication device for establishing wired communication via a network cable or a wireless communication device for establishing wireless communication via an antenna.

One example of hardware configuration of the production management device 100 has been described.

The processing unit 110 of such a production management device 100 is implemented via a program that causes the processing device 330 to execute processing. The program is stored in the main storage device 340 or the auxiliary storage device 350. For executing of the program, the program is loaded on the main storage device 340 to be executed by the processing device 330.

The input unit 130 is implemented by the input device 310. The output unit 140 is implemented by the output device 320. The storage unit 120 is implemented by the main storage device 340 or the auxiliary storage device 350, or a combination of both. The communication unit 150 is implemented by the communication device 360.

Regarding each of the above-described configurations, functions, processing units, processing means and the like of the production management device 100, some or all of them may be implemented with hardware, for example, by being designed in integrated circuitry and/or the like. The above-described configurations, functions may be implemented with software by the processor interpreting and executing a program that implements each function. Any information of a program, table, file and/or the like for implementing each function may be placed in a storage device such as memory, hard disk, SSD and/or the like or a recording medium such as an IC card, a SD card, DVD and the like.

The present invention is not limited to the above-described embodiments and modifications, and various modifications within the scope of the same technical idea are included. For example, the above-described embodiments have been described in detail for the purpose of describing the present invention in an easy-to-understand manner, and the present invention is not necessarily limited to including all the configurations described above. In addition, part of the configuration of one embodiment can be replaced with the configurations of other embodiments, and in addition, the configuration of the one embodiment can also be added with the configurations of other embodiments. Part of the configuration of each embodiment can be added to, omitted from or substituted for another configuration.

In the above description, control lines and information lines considered necessary for description are provided, but all the control lines and information lines are not necessarily provided in terms of products. In actual fact, it may be thought that almost all configurations are interconnected.

### LIST OF REFERENCE SIGNS

100: production management device
110: processing unit
111: actual result deviation detection unit
112: plan-change necessity determination unit
113: plan information generation unit
114: resource control information generation unit
115: plan-coordinating optimization unit
120: storage unit
121: actual production result information
122: production plan information
123: process plan information
124: resource control information
125: product quantity information
126: component shape information
127: cost information
130: input unit
140: output unit
150: communication unit
200: external device
310: input device
320: output device
330: processing device
340: main storage device
350: auxiliary storage device
360: communication device
370: bus
N: network

1. A production management device, performing production management of products using production plan information of products, process plan information pertaining to a production process of products, and resource control information defining operation of production resources which are manufacturing equipment,
wherein if a deviation occurs between a production plan of products and actual production results that indicate the progress of production, in the course of the production management carried out using the first production plan information, the first process plan information and the first resource control information, a determination is made to use the second process plan information and the second resource control information, which are different from the first process plan information and the first resource control information, instead of the first process plan information and the first resource control information.

2. The production management device according to claim 1,
wherein the second process plan information and the second resource control information are used to create the second production plan information as a change proposal of the production plan such that a predetermined production KPI (Key Performance Indicator) is maximized.

3. The production management device according to claim 2,
wherein the process plan information for maximization of the production KPI is selected as the second process plan information from among a plurality pieces of the process plan information.

4. The production management device according to claim 2,
wherein the resource control information for maximization of the production KPI is selected as the second resource control information from among a plurality pieces of the resource control information.

5. The production management device according to claim 2,
wherein the production KPI is either
a manufacturing cost including at least one of an equipment cost required for an arrangement change of equipment such as production resources and/or the like in a factory layout, a cost to operate a production resource, a ratio of profit to production yield, an outsourcing cost including cost per unit time of a worker and cost of overtime work of a worker, a penalty cost for delayed deliveries of products, and a penalty cost for delayed work, or
a production throughput which is a production volume of the products in a predetermined period of time, and
the second production plan information is created such that either the manufacturing cost takes a lower value or the production throughput takes a higher value.

6. A production management device, comprising:
a deviation detection unit that detects a deviation between a production plan of products and actual production results that indicate the progress of production;
a storage unit that stores production plan information of products, process plan information pertaining to a production process of products, and resource control information defining operation of production resources which are manufacturing equipment;
a plan information generation unit that, upon detection of the deviation, generates change proposals of the process plan information and the resource control information; and
a plan-coordinating optimization unit that uses the change proposals of the process plan information and the resource control information to create a change proposal of the production plan information such that a predetermined KPI (Key Performance Indicator) is maximized.

7. The production management device according to claim 6,
wherein the plan-coordinating optimization unit
uses a change proposal of the process plan information, a change proposal of resource control information and the production plan information to perform a production simulation in order to calculate a predicted value of a production throughput which is a production volume of the products in a predetermined period of time.

8. The production management device according to claim 7,
wherein the plan-coordinating optimization unit
determines net working time and setup time for the production resource from the change proposal of the process plan information and the change proposal of the resource control information, and
performs the production simulation in consideration of the net working time and the setup time in order to calculate the predicted value of the production throughput.

9. The production management device according to claim 6, further comprising
an output unit that uses the change proposal of the production plan information, the change proposal of the process plan information and the change proposal of the resource control information to generate control instruction information for controlling the production resource, and outputs the control instruction information to the production resource in a production line.

10. The production management device according to claim 6,
wherein the production KPI is an evaluation indicator for a manufacturing cost including at least one of an equipment cost required for an arrangement change of equipment such as production resources and/or the like in a factory layout, a cost to operate a production resource, a ratio of profit to production yield, an outsourcing cost including cost per unit time of a worker and cost of overtime work of a worker, a penalty cost for delayed deliveries of products, and a penalty cost for delayed work, and
the plan-coordinating optimization unit uses the change proposals of the production plan information, the process plan information and the resource control information to perform a production simulation in order to calculate the production KPI for the manufacturing cost.

11. A production management method for products, performed by a production management device using production plan information of products, process plan information pertaining to a production process of products, and resource control information defining operation of production resources which are manufacturing equipment,
wherein the production management device
performs a step for, if a deviation occurs between a production plan of products and actual production results that indicate the progress of production, in the course of the production management carried out using the first production plan information, the first process plan information and the first resource control information,
determining to use the second process plan information and the second resource control information, which are different from the first process plan information and the first resource control information, instead of the first process plan information and the first resource control information.

12. A production management method performed by a production management device,
wherein the production management device performs:
a deviation detecting step of detecting a deviation between a production plan of products and actual production results that indicate the progress of production;
a storing step of storing production plan information of products, process plan information pertaining to a production process of products, and resource control information defining operation of production resources which are manufacturing equipment;
a plan information generation step of, upon detection of the deviation, generating change proposals of the process plan information and the resource control information; and
a plan-coordinating optimization step of using the change proposals of the process plan information and the resource control information to create a change proposal of the production plan information such that a predetermined KPI (Key Performance Indicator) is maximized.

13. A program causing a computer to function as a production management device,
causing the computer:
to execute production management of products using production plan information of products, process plan information pertaining to a production process of products, and resource control information defining operation of production resources which are manufacturing equipment; and
if a deviation occurs between a production plan of products and actual production results that indicate the progress of production, in the course of the production management carried out using the first production plan information, the first process plan information and the first resource control information,
to perform production management using the second process plan information and the second resource control information, which are different from the first process plan information and the first resource control information, instead of the first process plan information and the first resource control information.

14. A program causing a computer to function as a production management device,
causing the computer to function as:
a deviation detection unit that detects a deviation between a production plan of products and actual production results that indicate the progress of production;
a storage unit that stores production plan information of products, process plan information pertaining to a production process of products, and resource control information defining operation of production resources which are manufacturing equipment;
a plan information generation unit that, upon detection of the deviation, generates change proposals of the process plan information and the resource control information; and
a plan-coordinating optimization unit that uses the change proposals of the process plan information and the resource control information to create a change proposal of the production plan information such that a predetermined KPI (Key Performance Indicator) is maximized.
